(19) United States
(12) Patent Application Publication
(10) Pub. No.: US 2009/0088230 A1
(43) Pub. Date: Apr. 2, 2009

(54) Watch phone

(76) Inventor: John Jeong Park, Boun-Kun (KR)

Correspondence Address: BEN E. LOFSTEDT, P.O. Box 4189, FULLERTON, CA, 92831, US

(21) Appl. No.: 11/906,222

(22) Filed: Oct. 1, 2007

(51) Int. Cl. H04M 1/02

(52) U.S. Cl. 455/575.6

(57) ABSTRACT

An improved cell phone mounted to a wrist strap or bracelet for protecting a combination device, such as a cell phone incorporating a watch function, from becoming lost, and to provide active utility means for re-charging the watch phone batteries and for purifying water for human consumption purposes.

### BACKGROUND OF THE INVENTION

The invention is primarily directed to a cell phone incorporating a watch function. More particularly, the invention is directed to an improved cell phone mounted to a wrist strap or bracelet for protecting a combination device, such as a cell phone incorporating a watch function, from becoming lost, and to provide active utility means for charging an electrical storage device or re-charging the watch phone batteries and for purifying water for human consumption purposes.

Cell phones with watch, or time-keeping functions, have literally become a way of life. Along with this way of life, such watch phones are prone to being damaged by being dropped to the ground or lost. If dropped, the cell phone may be either damaged or lost, or both.

Combination watch and phones, commonly known as cell phones, are carried by men, women and even teenagers, or young adults, and, less frequently, by children, wherever they may travel. These cell phones are small enough to be carried in a pocket or a handbag. Such personal cell phones have also been provided with custom-fitted protective carrying cases in which the phone instrument may be inserted and secured. Many presently available cell phone carrying cases are also furnished with a clip for attaching the carrying case to either the edge of a purse or to the user's waist belt.

When a cell phone is carried by the user in a pocket or purse or by a personal protective carrying case, the person using the phone must first remove the cell phone from its concealed position in a garment pocket, or purse, or from a belt

Cell phones, are often placed in a shirt or blouse pocket, and should the person bend over, such as when using certain toilet facilities, as the person bends over, the cell phone will frequently fall out onto the floor surrounding the toilet, or worse yet, directly into the water in the toilet bowl. This can also happen when the person bends over a stream, creek, river, seashore, or lake when in a wooded area, a wilderness, or forested area. Once the watch phone falls into the water, it is rapidly lost to view, and even if retrievable, it quickly becomes inoperative, and, in most cases, the cell phone cannot be restored again to operability.

When a cell phone is carried in a pocket or purse or mounted on the user's belt or backpack, the person using the phone must first retrieve the cell phone from its concealed position in a pocket, or purse, or from a carrying case on the user's belt. Once the cell phone is retrieved, it is no longer protected, as it is held in the person's hand. Then, the person must typically actuate selected key switches on the cell phone by the other (free) hand for dialing the phone. The dialed numbers typically are then displayed on a display monitor built into the cell phone. Once this is accomplished, the person must raise the cell phone to one of the person's ears, being held there in that hand for as long as the person using the cell phone is listening and speaking into the cell phone. Following the completion of the call, the cell phone is typically returned to a purse, a pocket in one of the user's garments, such as pants, shirt, or blouse, or to a belt-mounted carrying case. However, in these above-described cell phone handling operations, before being safely returned to the carrying case, the purse or the pocket, these cell phones frequently become misplaced or otherwise separate from their user-owners. In short, cell phones are oftentimes misplaced and lost.

If damaged, the cell phone may no longer be operative. If inoperative, all of the valuable (and personal) information logged into the cell phone, such as various personal and business contacts, voice messages, text messages, and photos, may no longer be available, or worst yet, lost forever. If such is lost, the contact information must be gathered again and re-entered into the new replacement cell phone.

If not damaged, but lost, all of the information in the cell phone may be accessed and stolen by the finder of the cell phone, and/or the finder may wrongfully use the cell phone to run up a huge telephone bill that the rightful cell phone owner may have to pay. This could result in thousands of dollars worth of damage to the rightful cell phone owner.

Yet another troublesome characteristic of such cell phones is that they are ill-suited to being carried by women. The reasons are many, but one typically stands out. Women's suits, dresses and other garments frequently lack pockets that are appropriate to retain and comfortably carry a cell phone.

A still further troublesome feature involving women's apparel is that such frequently lacks a waist belt sufficiently sturdy to carry such cell phone carrying cases without causing either damage to the belt or discomfort, or both, to the wearer.

Therefore, there is a need for a more secure and more convenient means for carrying and utilizing cell phones.

One of the significant problems facing cell phone users is due to the fact that many cell phones currently in use are of the flip-phone variety. Such flip-phones require that the user utilize both hands to pick up the phone with one hand and to flip it open for use using the other hand. Such two-handed cell phone operation is highly undesirable and inconvenient when the user is driving an automobile, riding a bicycle, operating a motorcycle, carrying groceries or a business briefcase in one hand, or even a young child. In these common-place situations, in order to use the cell phone, the user must stop driving (or momentarily take both hands off the steering wheel—a highly unsafe, dangerous and virtually always illegal), stop the bike or motorcycle, set down the groceries, or briefcase, or child. In point of fact, even users of non-flip phones are faced with the same type of problem and difficulty.

In view of this typical problem, there is a growing need for a automatic phone call answering feature which allows the phone to be answered by raising the phone from it's parked position to the users ear, and an automatic phone call termination feature which terminates the phone call when the phone is returned to its former parked position.

Another problem facing cell phone users is that the cell phone is battery powered. Once the battery is depleted, the cell phone is no longer operable. Replacement or re-charging of the battery is necessary in order to restore the cell phone to operability. Most cell phone users do not carrying replacement batteries for their cell phones. The reasons are many. First, it is inconvenient to carry extra cell phone batteries. Second, if carried in a purse, the terminals of the cell phone battery may engage a metal element, such as coins, metal lipstick housings, metal jewelry, metal encased pens, and the like, which will rapidly discharge the battery and wear out the battery, thereby rendering the battery inoperative. Thirdly, such batteries are expensive.

Consequently, there is a tremendous and growing need for a convenient automatic electrical generating device for charging an electrical energy storage device or for re-charging the battery powering the cell phone.

Cell phones are used throughout the world. In areas where there is yet no cell phone coverage (cell phones operate at microwave line-of-sight frequencies which require multiple cell phone repeaters mounted on vertical towers or buildings in order to provide operational cell phone coverage over a specific geographical area or territory.), satellites in orbit around the Earth are connected with “satellite” phones to communicate with other satellite phone users and even cell phone users. Consequently, such mobile phones, whether cell or satellite, are employed all over the globe throughout the World. In many areas of the World the water is contaminated with disease-producing bacteria, germs and viruses. While many water-filtration devices are employed to kill or otherwise eliminate the disease producing effects of germs and bacteria, there is no known water filtration device yet developed which can kill or eliminate the disease-producing effects of viruses.

It is also noted that persons in a particular area, country or part of the World can become highly tolerant, and, perhaps, immune from the particular kind and type of germs and bacteria in the water that they drink, but even so, when tourists from other parts of the World come to visit, should they drink the local water, they often become sickened by the local germs and bacteria in the water because they have not developed a tolerance or immunity such as the local inhabitants have.

However, it is well-known fact that disease-producing bacteria, germs and viruses can be killed, or their respective disease-producing characteristics, in the water can be rendered harmless to humans, by bathing the water in ultraviolet light.

Since cell phones and satellite phones are virtually universal throughout the World, it is both needful and convenient that such phones incorporate an ultraviolet light source for convenient drinking water purification.

### OBJECTS AND FEATURES OF THE INVENTION

The invention is primarily directed to a cell phone incorporating a watch function. More specifically, the within invention is directed to an improved cell phone mounted to a wrist strap or bracelet for protecting a combination device, such as a cell phone incorporating a watch function, from becoming lost, and to provide active utility means for charging an electrical storage device or re-charging the watch phone batteries and for purifying water for human consumption purposes.

Several features and objects of the instant invention referred to as a watch phone as disclosed and described herein are described hereinbelow.

It is one object and feature of the present invention to provide for at least one basic need for a more secure and more convenient means for carrying and utilizing cell phones is accomplished in accordance with the invention by the inclusion of a wrist band that permits the cell phone to be securely and comfortably attached to a person's arm.

It is yet another feature and object of my invention to satisfy and fulfill the need for an automatic phone call answering feature which allows the phone to be answered by raising the phone from it's parked position to the users ear, and an automatic phone call termination feature which terminates the phone call when the phone is returned to its former parked position.

Another object and feature of my invention which I have disclosed and described in detail herein to provide for a cell phone which is conveniently and comfortably secured about the wrist via a strap or bracelet, or even, as appropriate, about the person's forearm, the watch phone may be raised to a position near to the person's ear while concurrently activating the watch phone placing it in it's answering mode. When the telephone conversation is completed, the person lowers his arm, the watch phone is concurrently deactivated placing the watch phone in it's termination mode.

It is yet a still further and important feature and object of my watch phone invention which is worn about the wrist to incorporate a weighted eccentric driving a gear coupled to a small electric generator to re-charge the watch phone's battery. As the wrist phone is worn on the wrist the wrist, the wrist is constantly being moved and turned. During this type of wrist movement, the combination weighted eccentric driving a gear coupled to a small electric generator, an electric current is generated during each movement of the weighted eccentric driving the electric generator for charging an electrical energy storage device such as a capacitor or for re-charging the battery of the watch phone, thereby meeting the tremendous need for a convenient battery re-charging systems for cell phones.

Another important and significant feature of the present invention described herein is the incorporation of an ultraviolet light source in my unique watch phone in order to meet the great need for a convenient means for killing or eliminating the harmful effects of germ or bacteria or virus in drinking water.

### BRIEF DESCRIPTION OF THE FIGURES

FIG. 1 is a side elevational view of the present invention showing how my Watch Phone is securely affixed in operation position on the wrist of the user detailing one type of watchbands which are typically used by men shown in the listening and speaking position ready to be placed close to the ear and mouth of the user.

FIG. 2 is a perspective view of the present invention depicting the use of a wide wrist strap with a hook and pile fastening system to secure the Watch Phone about the wrist of the user.

FIG. 3 is a cross-sectional view taken through the wrist of the user depicting the use of a wide wrist strap with a hook and pile fastening system to secure the Watch Phone about the wrist of the user.

FIG. 4 is a horizontal edge view of the instant invention showing my Watch Phone With a flip cover for the face of the cell phone with a singular and different type of bracelet about the user's wrist typically used by women.

FIG. 5 is an elevational view of the present invention depicting the ultra violet light illumination source with an optical light conducting probe optically coupled to the ultra violet light source depending from the present invention disclosed herein.

FIG. 6 is a plan view of the rotatable weighted eccentric driving a gear coupled to a small electric generator to charge the electrical storage device or to re-charge the watch phone's battery.

FIG. 7 shows the position sensitive switch so that when the watch phone is mounted on the user's wrist and a incoming call is signaled by ringing tones or vibration when the watch phone user raises his wrist the cell phone is turned ON as it is placed adjacent to the user's mouth and ear to listen and speak. When the call is finished or otherwise terminated, and the user lowers his wrist below his or her shoulder level, the cell phone is turned OFF.

FIG. 8 illustrates one form of electrical storage device—a capacitor.

### DETAILED DESCRIPTION OF THE PREFERRED EMBODIMENT

With continuing reference to all of the Figures herein, there is generally shown an watch phone generally indicated at 10 mounted to a wrist strap 11a, 11b or bracelet 12 for securing the combination device known as a watch phone 10, including a cell phone 13 incorporating a watch function, about the wrist 14 of a person in order to protect the watch phone 10 from becoming lost, and to provide an electrical energy utility means 14 consisting of a weighted rotatable eccentric 15 coupled to a gearing mechanism 29 linked to an electric generating device 16 for charging an electrical energy storage device 17 or for re-charging the watch phone batteries.

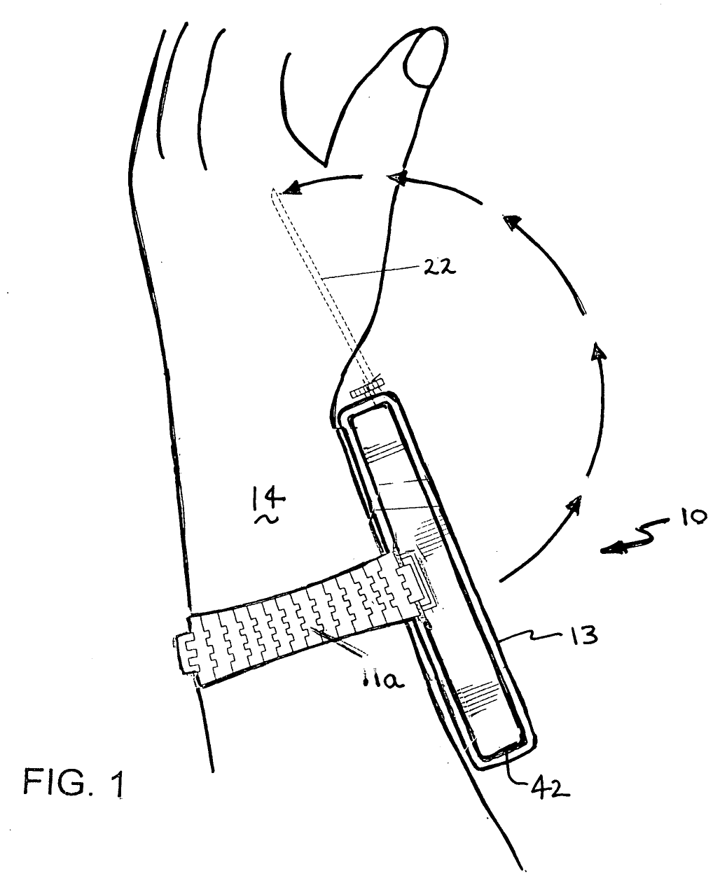

Especially noted in FIG. 1 there is shown and illustrated a cell phone 13 with a flip-type cover 22 to protect the cell phone's monitor window and the key pad.

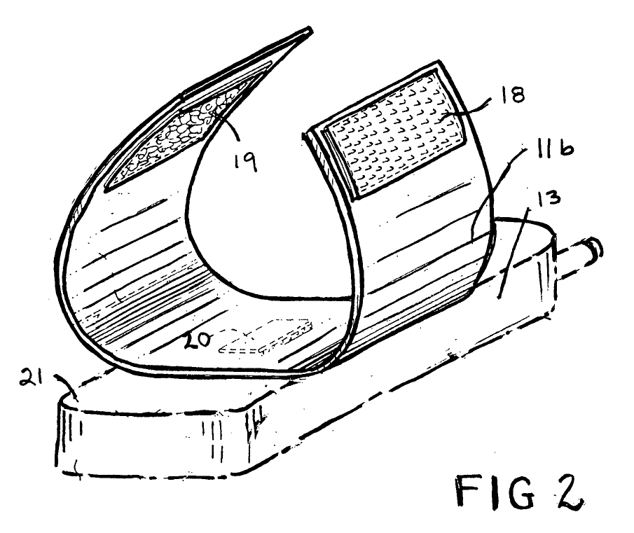

With special emphasis now on FIG. 2, there is shown and illustrated a cell phone 13 adhesively coupled to a wrist strap 11b having a hook 18 and pile 19 fastening closure system. The adhesive 20 couples the mid-point portion of the wrist strap 11b to the backside 21 of the cell phone 13. The adhesive 20 could, of course, be substituted using a pair of magnets, one magnet being secured to the backside 21 of the cell phone 13 and the other magnet being secured to the mid-point portion of the wrist strap 11b. Alternatively, it is also obvious to substitute a hook and pile fastening system in place and stead of the adhesive 20 with the pile portion being secured to the mid-point portion of the wrist strap 11b and the hook portion of the hook and pile system being secured to the backside 21 of the cell phone 13. Use of either the magnets or the hook and pile fastening system would allow the cell phone 13 to be separable and engageable from the wrist strap 11b. Such might be desireable under varying conditions, or simply personal preference by the user.

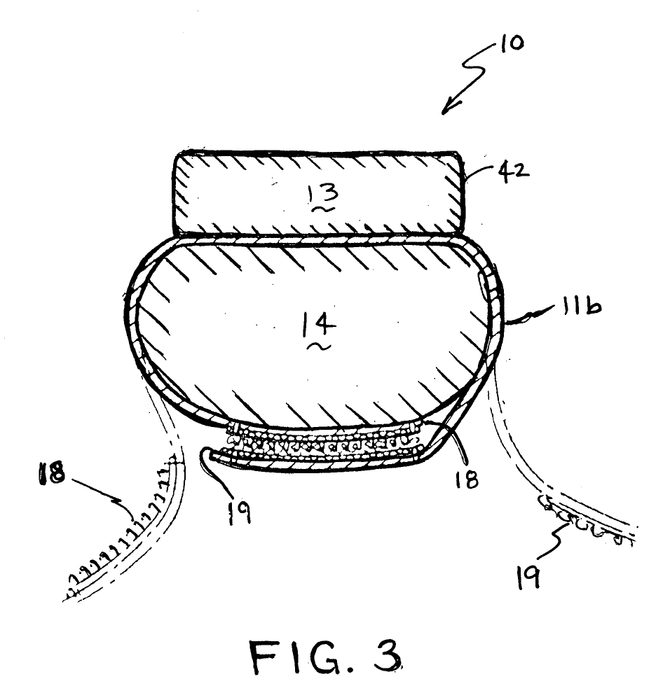

Turning now to FIG. 3, there is shown a cross-section view of the watch phone 10 illustrating the cell phone 13 secured to the wrist strap 11b and securely fastened about the user's wrist 14 using a hook 18 and pile 19 fastening system.

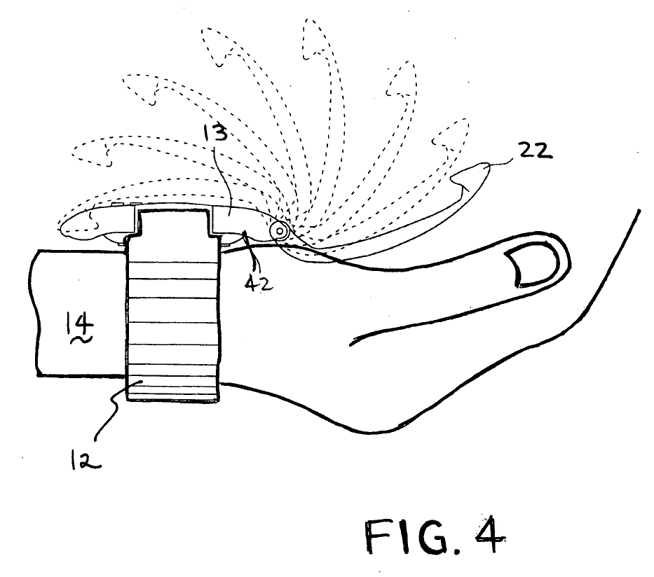

With special emphasis now on FIG. 4, a flip-cover 22 is shown in conjunction with the cell phone 13 secured to a bracelet 12 such as might be preferably worn by a woman. The range of motion of the flip cover 22 is shown from it's cover the cell phone monitor and the key pad to the fully extended, or “open”, position.

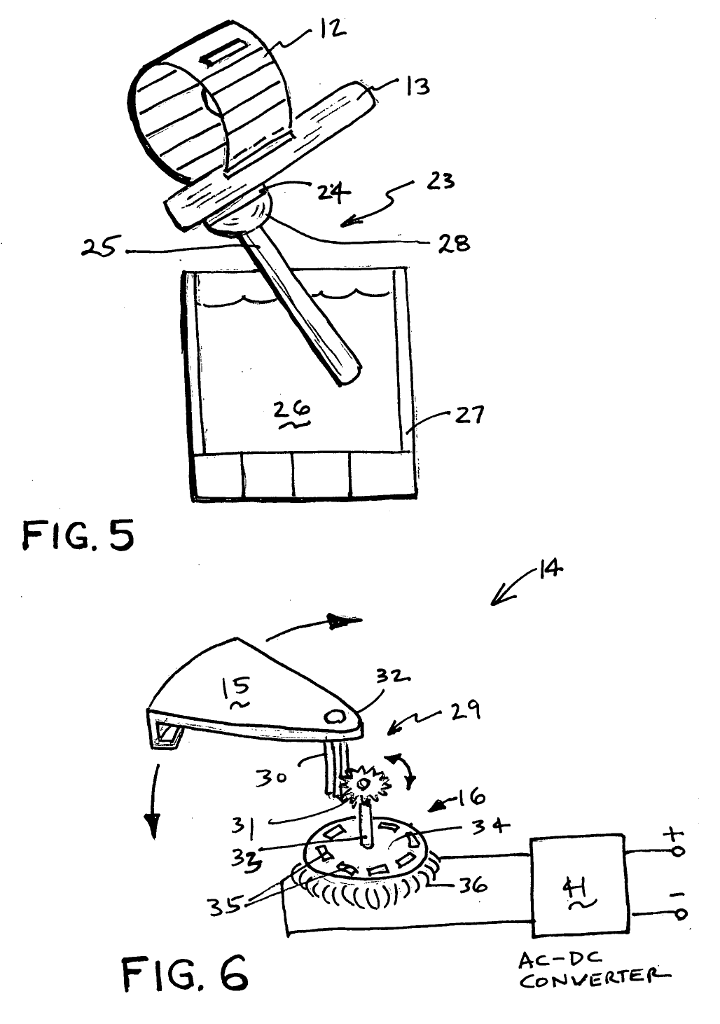

Turning now specifically to FIG. 5, there is additionally shown the watch phone 10 incorporating means for purifying water for human consumption purposes generally indicated at 23. This water purifying system utilizes a battery-powered ultraviolet light source 24 which is incorporated in the watch phone 10. As shown and illustrated in FIG. 5, the ultraviolet light source 24 can be optically coupled to a suction cup 28 and rod element 25 formed of transparent plastic or glass material. This suction cup 28 and rod element 25 combination concentrates and conducts the ultraviolet light from the ultraviolet light source 24 into the and below the surface of the water 26 contained in a 13 of 18 small glass 27 of the water to be purified. The use of the suction cup 28 and rod element increases the speed at which the water purification occurs.

Water purification by the ultraviolet light method is limited to killing germs, bacteria and viruses. It does not remove, or assist in the removal of particulate matter such as mud, sand, and the like.

With special reference to FIG. 6, there is shown one embodiment of an electrical energy utility means generally indicated at 14 consisting of a weighted rotatable eccentric 15 coupled to a gearing mechanism generally indicated at 29 linked to an electric generating device generally indicated at 16 for charging an electrical energy storage device 17 or for re-charging the watch phone batteries. The weighted rotatable eccentric 15 is pivotally secured to the gearing mechanism 29. The gearing mechanism 29 consists of two gears; gear 30 and gear 31. Gear 30 is fixedly secured to the pivoting end 32 of the weighted rotatable eccentric 15. Gear 30 is intermeshed with gear 31 so that when gear 30 moves in one direction, gear 31 rotates in the opposite direction, and visa versa. Gear 31 is mounted on a shaft 33 which is fixedly secured to a disk 34 having a plurality of magnets 35 mounted thereon. The disk 34 is disposed in close proximity to a coil of electrical wiring 36 so that when the magnets 35 are moved back and forth by the weighted rotatable eccentric 15 the magnetic field the rapid magnetic flux as it cuts through the wiring of the coil 36 an alternating current is generated and delivered into an AC to DC converter 41 whereby the AC produced is converted to DC to be used for re-charging the batteries, or, alternatively, for charging the electrical energy storage device 17, such as a capacitor 37 as schematically illustrated in FIG. 8.

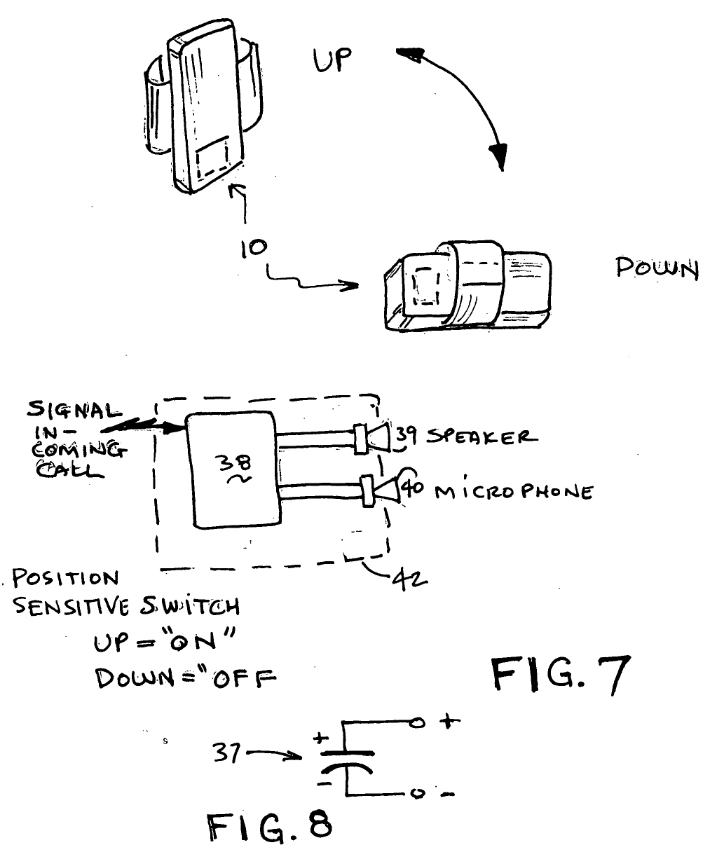

Turning now our attention to FIG. 7, there is shown and illustrated the two positions of the watch phone 10. One position is the UP position and the other position is the DOWN position. The UP position is the position of the watch phone 10 attached to the wrist 14 of the user when it is raised to engage the mouth and the ear of the watch phone 10 user. The DOWN position is the position of the watch phone 10 when the user lowers the watch phone 10 thereby disengaging the mouth and the ear of the watch phone 10 user. Illustrated further in FIG. 7 is the incorporation of a POSITION SENSITIVE SWITCH 38 which is fixedly secured either inside the housing 42 of the cell phone 13 or on the outside thereof so that when the watch phone 10 user is notified that a call is coming in and the cell phone 13 either rings or vibrates (or does both), when the watch phone 10 user raises his wrist 14 to his ear and mouth, the position sensitive switch 38 is activated or turned “ON” thereby electrically turning “ON” the cell phone 13 speaker 39 and the microphone 40 for use by the cell phone 13 user. When the call is terminated or ended, the cell phone 13 user drops his wrist 14 from his ear and mouth to a position below his or her shoulders and the position sensitive switch is switched to it's “OFF” position.

Many changes and modifications in the above-described embodiments of the invention, can, of course, be carried out without departing from the scope thereof, said scope intended to be limited only by the breadth of the claims herein. Further, the present invention may include an novel feature or combination of features disclosed herein either explicitly or implicitly or any generalization thereof irrespective of whether or not it relates to the presently claimed invention or mitigates any or all of the problems addressed. Accordingly, to promote the progress in science and the useful arts, the invention disclosed and in view of the foregoing description it will evident to a person skilled in the art to which this invention pertains that various modifications may be made within the scope of the invention without departing from the scope thereof, the scope being only intended to be limited only the claims appended hereto.

What I claim as my invention is:

1. A watch phone comprising:
(a) a mobile phone having a watch function;
(b) means for removably securing said mobile phone about the wrist of a user;
(c) electrical generation means actively producing electrical energy by the movement of the user's wrist to operate said mobile phone.

2. The watch phone of claim 1 further comprising battery means for electrically powering said mobile phone.

3. The watch phone of claim 1 further comprising water purification means.

4. The watch phone of claim 3 wherein said water purification means is ultraviolet light powered by said electrical generation means.

5. The watch phone of claim 3 wherein said water purification means is ultraviolet light powered by said battery means.

6. The watch phone of claim 4 further comprising optical probe means for optically coupling said ultraviolet light into the water to be purified.

7. The watch phone of claim 1 further comprising means for activating said mobile phone when said mobile phone gives notice that a call is being received and the wrist is moved from its down position to a position adjacent to the mouth and ear of the user for listening and speaking into said mobile phone.

8. The watch phone of claim 1 further comprising means for deactivating said mobile phone when said mobile phone call is terminated and the wrist is moved from its up position adjacent to the mouth and ear of the user for listening and speaking into said mobile phone to wrist position below the shoulders of the user.

9. The watch phone of claim 1 further comprising electrical energy storage means for accumulating the electricity generated by said electrical generation means.

10. The watch phone of claim 9 wherein said electrical energy storage means is an electrical capacitor.
